(19) United States
(12) Patent Application Publication
(10) Pub. No.: US 2015/0205320 A1
(43) Pub. Date: Jul. 23, 2015

(54) SYSTEM AND METHOD FOR COPING WITH BLACKOUT BASED ON REAL-TIME POPULATION DISTRIBUTION

(71) Applicant: Electronics and Telecommunications Research Institute, Daejeon (KR)

(72) Inventors: Shin Yuk KANG, Seoul (KR); Il Woo LEE, Daejeon (KR)

(21) Appl. No.: 14/600,079

(22) Filed: Jan. 20, 2015

(30) Foreign Application Priority Data
Jan. 23, 2014 (KR) 10-2014-0008255

(51) Int. Cl. G05F 5/00; G05B 15/02

(52) U.S. Cl. CPC G05F 5/00; G05B 15/02

(57) ABSTRACT

Provided are a system and method for coping with a blackout based on real-time population distribution. An apparatus for coping with a blackout based on real-time population distribution prepares for rolling blackouts while ensuring the safety of people's lives as much as possible by, when a blackout is inevitable due to an increase in power demand, implementing rolling blackouts mainly in regions in which there are a smaller number of people than a previously set number of people, providing notifications of rolling blackout times in advance, notifying people in a region not to be blacked out that no blackout will occur, etc.

### CROSS-REFERENCE TO RELATED APPLICATION

This application claims priority to and the benefit of Korean Patent Application No. 10-2014-0008255, filed on Jan. 23, 2014, the disclosure of which is incorporated herein by reference in its entirety.

### BACKGROUND

1. Field of the Invention

The present invention relates to a system and method for coping with a blackout based on real-time population distribution, and more particularly, to an apparatus and method for notifying people of rolling blackouts when an electric power reserve rate is reduced and there are needs for rolling blackouts and notification to users.

2. Discussion of Related Art

A preceding patent (publication No. 10-2007-0035871) relates to a method of providing a disaster broadcasting guide service in a disaster broadcasting guide system connected with mobile communication terminals, which are capable of receiving a digital broadcast, through a wireless network. The methods includes a process of generating a viewer recommendation message for disaster broadcasting that is broadcast by a predetermined broadcasting station upon occurrence of a disaster, and a process of transmitting the generated viewer recommendation message to mobile communication terminals in a region in which the disaster has occurred.

In other words, a disaster broadcasting guide system and method for providing a disaster broadcasting guide service according to the preceding patent (publication No. 10-2007-0035871) provide a disaster broadcasting guide service through mobile communication terminals capable of receiving digital broadcasting in a disaster situation so that users in the corresponding region may rapidly recognize the disaster situation. A viewer recommendation message for disaster broadcasting is transmitted to the mobile communication terminals in the region in which the disaster has occurred so that the mobile communication terminals may automatically receive the disaster broadcasting. Therefore, the users of the mobile communication terminals may rapidly recognize and cope with the emergency disaster situation, thereby reducing damage to human lives and property and improving the users' convenience.

In addition, according to a preceding patent (publication No. 10-2010-0133573), after geographic information and location information of a base station included in disaster information is extracted from broadcast information received from the base station, the distance between the positions of the geographic information and the location information is determined, and a previously set alarm is output according to the distance. Also, when a disaster occurs, the location of a user is found based on geographic information included in the disaster information, and an alarm providing a notification of the disaster is output according to the distance between the user and a location at which the disaster has occurred.

In other words, in a disaster information management method based on a broadcasting network and a portable terminal supporting the method according to the preceding patent (publication No. 10-2010-0133573), location information of a portable terminal is compared with geographic information of disaster information, and more accurate disaster information according to the current location of the portable terminal is obtained and checked to respond to the disaster. When disaster information in a strong relationship with the current location of the portable terminal is obtained, it is possible to rapidly cope with the disaster, and when disaster information in a weak relationship with the portable terminal is obtained, an unnecessary reaction may be prevented. Therefore, it is possible to support a flexible and reliable disaster information service.

Meanwhile, a blackout occurs due to a drastically increasing energy load, and thus it is very difficult to predict the time or the time point of a blackout.

Actually, there is not much time until a determination about a blackout is made after an electric power reserve rate begins to decrease. Therefore, it is necessary to prepare a measure against a blackout at an alarm stage.

When a specific facility is blacked out in a specific region, there is economic loss. However, in consideration of such economic loss, it is very difficult to determine a facility and a region to be blacked out first.

### SUMMARY OF THE INVENTION

The present invention is directed to providing an apparatus and method for coping with a blackout based on real-time population distribution to prepare for rolling blackouts while ensuring the safety of people's lives as much as possible by: when a blackout is inevitable due to an increase in power demand, implementing rolling blackouts mainly in regions in which there are a smaller number of people than a previously set number of people, providing notifications of rolling blackout times in advance, notifying people in a region not to be blacked out that no blackout will occur, etc.

According to an aspect of the present invention, there is provided an apparatus for coping with a blackout based on real-time population distribution, the apparatus including: a coping unit configured to, when power information is received from a power information server, request a real-time population distribution result from a mobile communication service provider server and transmit the received power information to a micro energy grid management system; an information collection unit configured to collect information of a power generation amount resulting from self-power generation performed based on the power information, from the micro energy grid management system; and a calculation unit configured to calculate an amount of reserved backup power based on the collected power generation amount information. The coping unit selects a specific region in which a rolling blackout will be implemented based on at least one of the calculated amount of reserved backup power, real-time population distribution result information received from the mobile communication service provider server, and priority order information of previously set regions, determines a rolling blackout implementation time of the selected specific region, and transfers the rolling blackout implementation time to an energy management system of the selected specific region so that a rolling blackout is implemented according to the determined rolling blackout implementation time.

According to another aspect of the present invention, there is provided a method of coping with a blackout based on real-time population distribution, the method including: when power information is received from a power information server, requesting a real-time population distribution result from a mobile communication service provider server and transmitting the received power information to a micro energy grid management system; collecting information of a power generation amount resulting from self-power generation performed based on the power information, from the micro energy grid management system; calculating an amount of reserved backup power based on the collected power generation amount information; selecting a specific region in which a rolling blackout will be implemented based on at least one of the calculated amount of reserved backup power, real-time population distribution result information received from the mobile communication service provider server, and priority order information of previously set regions, and determining a rolling blackout implementation time of the selected specific region; and transferring the rolling blackout implementation time to an energy management system of the selected specific region so that a rolling blackout is implemented according to the determined rolling blackout implementation time.

According to another aspect of the present invention, there is provided a system for coping with a blackout based on real-time population distribution, the system including: a power information server configured to transmit power information according to a reduction in an electric power reserve rate; a blackout coping apparatus configured to, when the power information is received, request a real-time population distribution result and transmit the received power information; a micro energy grid management system configured to, when the power information is received from the blackout coping apparatus, generate power by the micro energy grid management system itself and transmit information of a power generation amount resulting from self-power generation; and a mobile communication service provider server configured to calculate a real-time population distribution result of a population distribution investigation region corresponding to the request of the blackout coping apparatus and transmit the calculated real-time population distribution result. The blackout coping apparatus calculates an amount of reserved backup power based on the power generation amount information, selects a specific region in which a rolling blackout will be implemented based on at least one of the calculated amount of reserved backup power, the received real-time population distribution result, and priority order information of previously set regions, and causes an energy management system of the selected specific region to implement a rolling blackout.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a block diagram of a system for coping with a blackout based on real-time population distribution according to an exemplary embodiment of the present invention;

FIG. 2 is a block diagram of an apparatus for coping with a blackout based on real-time population distribution according to an exemplary embodiment of the present invention; and

FIG. 3 is a flowchart of a method of coping with a blackout based on real-time population distribution according to an exemplary embodiment of the present invention.

### DETAILED DESCRIPTION OF EXEMPLARY EMBODIMENTS

Exemplary embodiments of the present invention will now be described more fully with reference to the accompanying drawings to clarify aspects, features, and advantages of the present invention. The invention may, however, be embodied in many different forms and should not be construed as being limited to the embodiments set forth herein. Rather, these embodiments are provided so that this disclosure will be through and complete, and will fully convey the concept of the invention to those of ordinary skill in the art. Instead, the present invention is defined by the appended claims.

Meanwhile, the terms used herein are for the purpose of describing exemplary embodiments only and are not intended to be limiting. As used herein, the singular forms “a,” “an,” and “the” are intended to include the plural forms as well, unless the context clearly indicates otherwise. It will be further understood that the terms “comprises” or “comprising,” when used in this specification, do not preclude the presence or addition of one or more components, steps, operations, and/or elements other than a mentioned component, step, operation, and/or element.

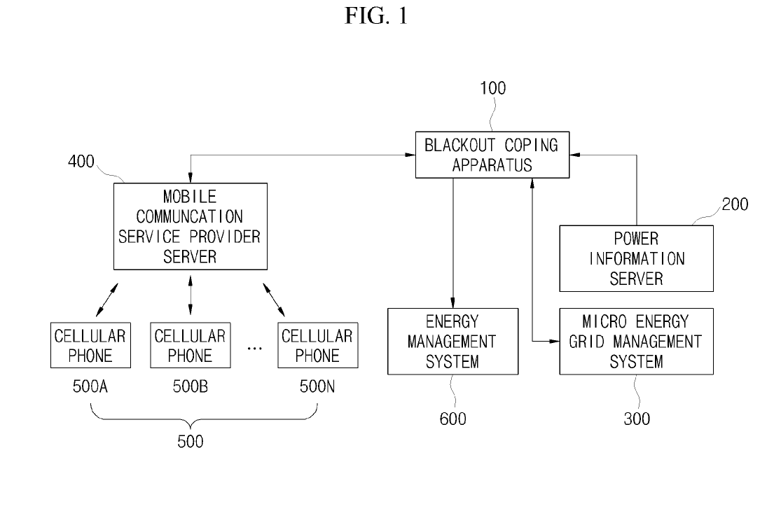

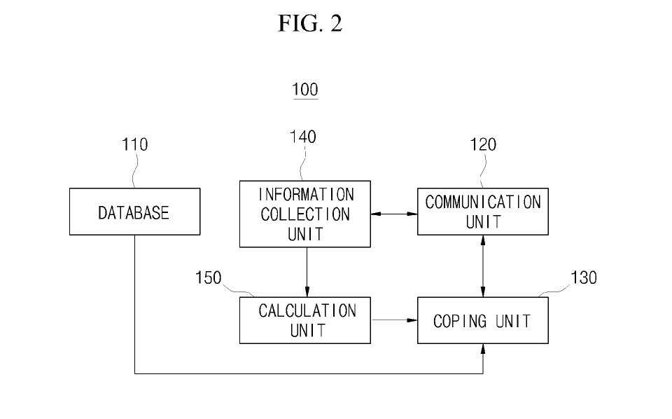

An apparatus for coping with a blackout based on real-time population distribution according to an exemplary embodiment of the present invention will be described in detail below with reference to FIGS. 1 and 2. FIG. 1 is a block diagram of a system for coping with a blackout based on real-time population distribution according to an exemplary embodiment of the present invention, and FIG. 2 is a block diagram of an apparatus for coping with a blackout based on real-time population distribution according to an exemplary embodiment of the present invention.

As shown in FIGS. 1 and 2, an apparatus 100 for coping with a blackout based on real-time population distribution according to an exemplary embodiment of the present invention includes a database 110, a communication unit 120, a coping unit 130, an information collection unit 140, and a calculation unit 150.

The database 110 stores information resulting from management of a previously built electrical grid, grade (priority order) information of regions determined according to importance of buildings or districts using electric power, etc.

Here, the highest-ranking region may be a region or a facility including a medical institution, a facility of national core industry, a national infrastructure facility, etc., to which power supply should not be stopped (having the highest importance), and the lowest-ranking region may be a district in which commercial facilities are distributed, a general residential district including residential buildings or apartments, etc.

When power information is received from a power information server 200, the communication unit 120 notifies the coping unit 130 that power information has been received from the power information server 200.

For example, when an electric power reserve rate is reduced and it is necessary to implement a blackout according to previously set coping information, the power information server 200 transmits power information including the reduced power reserve rate, a zero-reserve-rate time point, etc., to the blackout coping apparatus 100. When the power information is received from the power information server 200, the communication unit 120 notifies the coping unit 130 that power information has been received from the power information server 200.

When it is recognized that power information has been received by the communication unit 120, the coping unit 130 transmits the received power information to an emergency generator capable of independent operation or a micro energy grid management system 300 managing a region in which a micro energy grid has been built through the communication unit 120, and simultaneously requests a real-time population distribution result from a mobile communication service provider server 400 through the communication unit 120.

When a power information transmission instruction is received from the coping unit 130, the communication unit 120 transmits the power information received from the power information server 200 to an emergency generator capable of independent operation or the micro energy grid management system 300 managing a region in which a micro energy grid has been built. Also, when an instruction to request a real-time population distribution result of a specific region is received from the coping unit 130, the communication unit 120 transmits a real-time population distribution result request signal to the mobile communication service provider server 400.

When the power information is received from the blackout coping apparatus 100, the micro energy grid management system 300 performs a preparatory operation for self-power generation and external power interruption based on the received power information. When the preparation is completed, the micro energy grid management system 300 cuts off external power, generates power by itself, and transmits information of the amount of power generated by itself and the possible duration of self-power generation to the blackout coping apparatus 100.

When the real-time population distribution result request signal is received from the blackout coping apparatus 100, the mobile communication service provider server 400 investigates the real-time population distribution of people who currently have cellular phones 500, and transmits a result of the investigated real-time population distribution to the blackout coping apparatus 100.

For example, the real-time population distribution result request signal includes information on a population distribution investigation region, and the mobile communication service provider server 400 transmits a population distribution investigation signal to base stations in the population distribution investigation region. Each of the base stations transmits a response request signal to cellular phones in its service region. When response signals are received from the cellular phones, the base station counts the received response signals to determine the number of cellular phones in its service region, and transmits cellular phone information including the determined number of cellular phones to the mobile communication service provider server 400. The mobile communication service provider server 400 calculates a population distribution result of the population distribution investigation region based on cellular phone information received from the base stations, and transmits the calculated population distribution result to the blackout coping apparatus 100.

The communication unit 120 receives the real-time population distribution result from the mobile communication service provider server 400 and transfers the received real-time population distribution result to the coping unit 130.

The information collection unit 140 collects information on the amount of generated power and the possible duration of self-power generation from the micro energy grid management system 300 or the emergency generator capable of independent operation through the communication unit 120, and transfers the collected information to the calculation unit 150.

The calculation unit 150 calculates the amount of reserved backup power based on the received information of the generated power amount and the possible duration, and transfers the calculated amount of reserved backup power to the coping unit 130.

The coping unit 130 selects a specific region according to the real-time population distribution result, the calculated amount of reserved backup power, and the priority order of regions stored in the database 110, determines a rolling blackout start time, a duration, etc., of the selected specific region, and transfers the determined information to an energy management system 600 of the selected specific region through the communication unit 120 so that the rolling blackout may be implemented according to the determined information.

Also, a specific time period (about 30 minutes) before the energy management system 600 of the specific region (in which the rolling blackout is determined to be implemented) implements the determined rolling blackout the coping unit 130 transfers situation information, such as the rolling blackout start time and the duration, to people in the specific region through cellular phones 500, and transmits the determined information to the mobile communication service provider server 400 through the communication unit 120 so that an announcement that a region is not blacked out according to the priority order may be made.

Further, when the rolling blackout is completed before the end of the determined duration because of an increase in a power reserve rate, the coping unit 130 transmits the corresponding information to the mobile communication service provider server 400 through the communication unit 120 so that the corresponding information may be announced through the cellular phones 500 and people in the region in which the rolling blackout is determined to be implemented may do activities normally.

As described above, an exemplary embodiment of the present invention prevents people in a region in which no rolling blackout will be implemented from getting anxious about a nationwide blackout broadcasting or alarm, and also makes it possible to select regions in which rolling blackouts will be implemented so that the number of people damaged by the rolling blackouts is reduced as much as possible. Further, by delivering detailed information (blackout start times, blackout end times, information of surrounding regions that are not blacked out, etc.,) to people in the rolling blackout regions, it is possible to reduce as much inconvenience to their lives as possible.

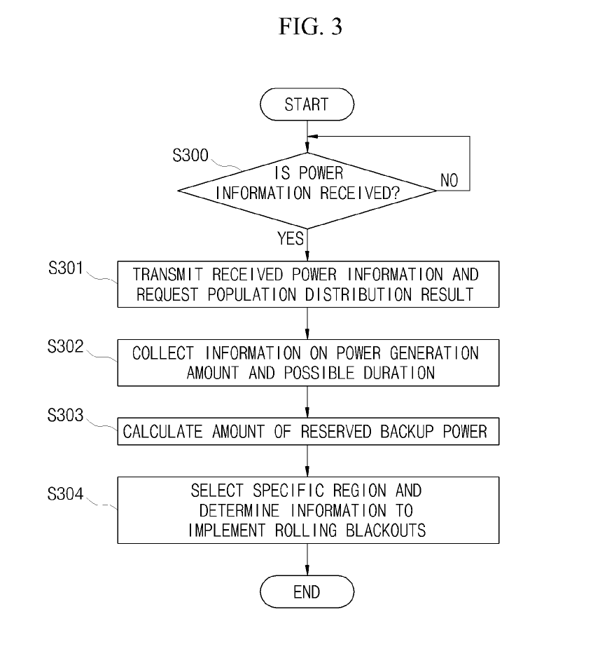

Thus far, an apparatus for coping with a blackout based on real-time population distribution according to an exemplary embodiment of the present invention has been described above with reference to FIGS. 1 and 2, and a method of coping with a blackout based on real-time population distribution according to an exemplary embodiment of the present invention will be described below with reference to FIG. 3. FIG. 3 is a flowchart of a method of coping with a blackout based on real-time population distribution according to an exemplary embodiment of the present invention.

As illustrated in FIG. 3, in a method of coping with a blackout based on real-time population distribution according to an exemplary embodiment of the present invention, the blackout coping apparatus 100 determines whether or not power information is received from the power information server 200 (S300).

For example, when an electric power reserve rate is reduced and it is necessary to implement a blackout according to previously set coping information, the power information server 200 transmits power information including the reduced power reserve rate, a zero-reserve-rate time point, etc., to the blackout coping apparatus 100.

When it is determined that the power information is received from the power information server 200, the blackout coping apparatus 100 transmits the received power information to an emergency generator capable of independent operation or the micro energy grid management system 300 managing a region in which a micro energy grid has been built, and simultaneously requests a real-time population distribution result from the mobile communication service provider server 400 (S301).

When the power information is received from the blackout coping apparatus 100, the micro energy grid management system 300 performs a preparatory operation for self-power generation and external power interruption based on the received power information. When the preparation is completed, the micro energy grid management system 300 cuts off external power, generates power by itself, and transmits information of the amount of power generated by itself and the possible duration of self-power generation to the blackout coping apparatus 100.

When the real-time population distribution result request is received from the blackout coping apparatus 100, the mobile communication service provider server 400 investigates the real-time population distribution of people who currently have cellular phones 500, and transmits a result of the investigated real-time population distribution to the blackout coping apparatus 100.

For example, the real-time population distribution result request signal includes information on a population distribution investigation region, and the mobile communication service provider server 400 transmits a population distribution investigation signal to base stations in the population distribution investigation region. Each of the base stations transmits a response request signal to cellular phones in its service region. When response signals are received from the cellular phones, the base station counts the received response signals to determine the number of cellular phones in its service region, and transmits cellular phone information including the determined number of cellular phones to the mobile communication service provider server 400. The mobile communication service provider server 400 calculates a population distribution result of the population distribution investigation region based on cellular phone information received from the base stations, and transmits the calculated population distribution result to the blackout coping apparatus 100.

The blackout coping apparatus 100 collects information on the amount of generated power and the possible duration of self-power generation from the micro energy grid management system 300 or the emergency generator capable of independent operation (S302).

The blackout coping apparatus 100 calculates the amount of reserved backup power based on the collected information on the generated power amount and the possible duration (S303), selects a specific region according to the calculated amount of reserved backup power, the real-time population distribution result, and the priority order of regions stored in the database 110, and determines a rolling blackout start time, a duration, etc., of the selected specific region (S304).

The blackout coping apparatus 100 transfers the determined information to an energy management system 600 of the selected specific region so that a rolling blackout may be implemented according to the determined information.

Also, a specific time period (about 30 minutes) before the energy management system 600 of the specific region (in which the rolling blackout is determined to be implemented) implements the determined rolling blackout, the blackout coping apparatus 100 transfers situation information, such as the rolling blackout start time and the duration, to people in the specific region through cellular phones 500, and transmits the determined information to the mobile communication service provider server 400 so that an announcement that a region is not blacked out according to the priority order may be made.

When the rolling blackout is completed before the end of the determined duration because of an increase in a power reserve rate, the blackout coping apparatus 100 transmits the corresponding information to the mobile communication service provider server 400 so that the corresponding information may be announced through the cellular phones 500 and people in the region in which the rolling blackout is determined to be implemented may do activities normally.

Exemplary embodiments of the present invention prevent people in a region in which no rolling blackout will be implemented from getting anxious about a nationwide blackout broadcasting or alarm, and also make it possible to select regions in which rolling blackouts will be implemented so that the number of people damaged by the rolling blackouts is reduced as much as possible.

Further, by delivering detailed information (blackout start times, blackout end times, information of surrounding regions that are not blacked out, etc.,) to people in the rolling blackout regions, it is possible to reduce as much inconvenience to their lives as possible.

It will be apparent to those skilled in the art that various modifications can be made to the above-described exemplary embodiments of the present invention without departing from the spirit or scope of the invention. Thus, it is intended that the present invention cover all such modifications provided they come within the scope of the appended claims and their equivalents.

What is claimed is:

1. An apparatus for coping with a blackout based on real-time population distribution, the apparatus comprising:
a coping unit configured to, when power information is received from a power information server, request a real-time population distribution result from a mobile communication service provider server and transmit the received power information to a micro energy grid management system;
an information collection unit configured to collect information of a power generation amount resulting from self-power generation performed based on the power information, from the micro energy grid management system; and
a calculation unit configured to calculate an amount of reserved backup power based on the collected power generation amount information,
wherein the coping unit selects a specific region in which a rolling blackout will be implemented based on at least one of the calculated amount of reserved backup power, real-time population distribution result information received from the mobile communication service provider server, and priority order information of previously set regions, determines a rolling blackout implementation time of the selected specific region, and transfers the rolling blackout implementation time to an energy management system of the selected specific region so that a rolling blackout is implemented according to the determined rolling blackout implementation time.

2. The apparatus of claim 1, wherein, before the energy management system of the selected specific region implements the determined rolling blackout, the coping unit transmits rolling blackout implementation information to the mobile communication service provider server so that people in the specific region receive rolling blackout situation information including a rolling blackout start time and duration through cellular phones and announcement information of regions not blacked out according to the priority order information of the previously set regions.

3. The apparatus of claim 1, wherein, when the rolling blackout of the specific region is completed before an end of the determined rolling blackout implementation time because of an increase in a power reserve rate, the coping unit transmits early rolling blackout completion information to the mobile communication service provider server so that people in the specific region are notified through cellular phones that the rolling blackout has been completed earlier.

4. The apparatus of claim 1, further comprising a database configured to store the priority order information of the previously set regions according to importance of buildings or districts using electricity,
wherein the database stores information of a region or a facility including at least one of a medical institution, a facility of national core industry, and a national infrastructure facility as a region of a highest priority, and stores information of a district in which commercial facilities are distributed or a general residential district including residential buildings or apartments as a region of a lowest priority.

5. The apparatus of claim 1, wherein, when an electric power reserve rate is reduced and it is necessary to implement a blackout according to previously set coping information, the power information server transmits the power information including at least one of a reduced power reserve rate and a zero-reserve-rate time point.

6. The apparatus of claim 1, wherein, when the power information is received from the coping unit, the micro energy grid management system performs a preparatory operation for the self-power generation and external power interruption based on the received power information, and
when the preparation is completed, the micro energy grid management system cuts off external power, generates power by the micro energy grid management system itself, and transmits information of an amount of power generated by the micro energy grid management system itself and a possible duration of the self-power generation.

7. The apparatus of claim 1, wherein, when a population distribution result request signal including information on a population distribution investigation region is received, the mobile communication service provider server transmits a population distribution investigation signal to a base station in the population distribution investigation region, calculates a population distribution result of the population distribution investigation region based on information received from the base station in the population distribution investigation region in response to the population distribution investigation signal, and transmits the calculated population distribution result.

8. The apparatus of claim 7, wherein the base station transmits a response request signal to cellular phones in a service region of the base station, and
when response signals are received from the cellular phones, the base station counts the received response signals to determine a number of cellular phones in the service region, and transmits cellular phone information including the determined number of cellular phones to the mobile communication service provider server.

9. A method of coping with a blackout based on real-time population distribution, the method comprising:
when power information is received from a power information server, requesting a real-time population distribution result from a mobile communication service provider server and transmitting the received power information to a micro energy grid management system;
collecting information of a power generation amount resulting from self-power generation performed based on the power information, from the micro energy grid management system;
calculating an amount of reserved backup power based on the collected power generation amount information;
selecting a specific region in which a rolling blackout will be implemented based on at least one of the calculated amount of reserved backup power, real-time population distribution result information received from the mobile communication service provider server, and priority order information of previously set regions, and determining a rolling blackout implementation time of the selected specific region; and
transferring the rolling blackout implementation time to an energy management system of the selected specific region so that a rolling blackout is implemented according to the determined rolling blackout implementation time.

10. The method of claim 9, further comprising, before the energy management system of the selected specific region performs the determined rolling blackout, transmitting rolling blackout implementation information to the mobile communication service provider server so that people in the specific region receive rolling blackout situation information including a rolling blackout start time and duration through cellular phones and announcement information of regions not blacked out according to the priority order information of the previously set regions.

11. The method of claim 9, further comprising, when the rolling blackout of the specific region is completed before an end of the determined rolling blackout implementation time because of an increase in a power reserve rate, transmitting early rolling blackout completion information to the mobile communication service provider server so that people in the specific region are notified through cellular phones that the rolling blackout has been completed earlier.

12. The method of claim 9, further comprising storing the priority order information of the previously set regions according to importance of buildings or districts using electricity,
wherein the storing of the priority order information of the previously set regions includes:
storing information of a region or a facility including at least one of a medical institution, a facility of national core industry, and a national infrastructure facility as a region of a highest priority; and
storing information of a district in which commercial facilities are distributed or a general residential district including residential buildings or apartments as a region of a lowest priority.

13. The method of claim 9, further comprising, when an electric power reserve rate is reduced and it is necessary to implement a blackout according to previously set coping information, transmitting, by the power information server, the power information including at least one of a reduced power reserve rate and a zero-reserve-rate time point.

14. The method of claim 9, further comprising:
when the power information is received, performing, by the micro energy grid management system, a preparatory operation for the self-power generation and external power interruption based on the received power information; and
when the preparation is completed, cutting off, by the micro energy grid management system, external power, generating power by the micro energy grid management system itself, and transmitting information of an amount of power generated by the micro energy grid management system itself and a possible duration of the self-power generation.

15. The method of claim 9, further comprising:
when a population distribution result request signal including information on a population distribution investigation region is received, transmitting, by the mobile communication service provider server, a population distribution investigation signal to a base station in the population distribution investigation region; and
calculating, by the mobile communication service provider server, a population distribution result of the population distribution investigation region based on information received from the base station in the population distribution investigation region in response to the population distribution investigation signal, and transmitting the calculated population distribution result.

16. The method of claim 15, further comprising:
transmitting, by the base station, a response request signal to cellular phones in a service region of the base station;
when response signals are received from the cellular phones, counting, by the base station, the received response signals to determine a number of cellular phones in the service region; and
transmitting, by the base station, cellular phone information including the determined number of cellular phones to the mobile communication service provider server.

17. A system for coping with a blackout based on real-time population distribution, the method comprising:
a power information server configured to transmit power information according to a reduction in an electric power reserve rate;
a blackout coping apparatus configured to, when the power information is received, request a real-time population distribution result and transmit the received power information;
a micro energy grid management system configured to, when the power information is received from the blackout coping apparatus, generate power by the micro energy grid management system itself and transmit information of a power generation amount resulting from self-power generation; and
a mobile communication service provider server configured to calculate a real-time population distribution result of a population distribution investigation region corresponding to the request of the blackout coping apparatus and transmit the calculated real-time population distribution result,
wherein the blackout coping apparatus calculates an amount of reserved backup power based on the power generation amount information, selects a specific region in which a rolling blackout will be implemented based on at least one of the calculated amount of reserved backup power, the received real-time population distribution result, and priority order information of previously set regions, and causes an energy management system of the selected specific region to implement a rolling blackout.

18. The system of claim 17, wherein the mobile communication service provider server transmits a population distribution investigation signal to a base station in the population distribution investigation region, calculates a population distribution result of the population distribution investigation region based on information received from the base station in the population distribution investigation region in response to the population distribution investigation signal, and transmits the calculated population distribution result.

19. The system of claim 18, wherein the base station transmits a response request signal to cellular phones in a service region of the base station, and
when response signals are received from the cellular phones, the base station counts the received response signals to determine a number of cellular phones in the service region, and transmits cellular phone information including the determined number of cellular phones to the mobile communication service provider server.

20. The system of claim 17, wherein, when an electric power reserve rate is reduced and it is necessary to implement a blackout according to previously set coping information, the power information server transmits the power information including at least one of a reduced power reserve rate and a zero-reserve-rate time point.
